(19) United States
(12) Patent Application Publication
(10) Pub. No.: US 2026/0080596 A1
(43) Pub. Date: Mar. 19, 2026

(54) INFORMATION PROCESSING SYSTEM, INFORMATION PROCESSING METHOD, AND PROGRAM

(71) Applicant: RIGAKU CORPORATION, Tokyo (JP)

(72) Inventor: Takumi OTA, Tokyo (JP)

(73) Assignee: RIGAKU CORPORATION, Tokyo (JP)

(21) Appl. No.: 19/280,145

(22) Filed: Jul. 25, 2025

(30) Foreign Application Priority Data
Sep. 19, 2024 (JP) 2024-162715

(51) Int. Cl. G06T 11/00

(52) U.S. Cl. CPC G06T 12/10; G06T 2211/408; G06T 2211/448

(57) ABSTRACT

An information processing system is provided, including circuitry configured to: acquire projection data representing an X-ray CT projection image related to an object to be measured and an absorption model related to a mode of absorption of X-rays by the object, the projection data including information on the projection image(s) corresponding to azimuths where incident X-rays are applied to the object; generate corrected projection data for each candidate of hypothetical incident X-rays, the corrected projection data being the projection data in which correction on the basis of the candidate of hypothetical incident X-rays and the absorption model is performed; calculate a consistency index indicating a degree of consistency of the corrected projection images corresponding to the azimuths for each of the corrected projection data generated; and an output unit configured to output, on the basis of the consistency index, at least one piece of the corrected projection data generated.

### CROSS-REFERENCE TO RELATED APPLICATION

The present application claims priority under 35 U.S.C. § 119 to Japanese Patent Application No. 2024-162715, filed Sep. 19, 2024. the contents of which are incorporated herein by reference in their entirety.

### BACKGROUND ART

The present invention relates to an information processing system, information processing method, and program. Duan X, Wang, et. al., CT scanner x-ray spectrum estimation from transmission measurements. Med Phys. 2011 February; 38 (2): 993-7 discloses a method for estimating the spectra of incident X-rays. For example, this literature 1 discloses a method of estimating the spectra of incident X-rays actually applied to an object to be measured by applying X-rays to a structure having a known linear absorption coefficient and measuring the intensity of the transmitted X-rays. T. Würfl et. al., 8th Conference on Industrial Computed Tomography, Wels. Austria (iCT 2018) is a reference.

See Duan X, Wang, et. al., CT scanner x-ray spectrum estimation from transmission measurements. Med Phys. 2011 February; 38 (2): 993-7 and T. Würfl et. al., 8th Conference on Industrial Computed Tomography, Wels. Austria (ICT 2018).

### SUMMARY

With respect to X-ray CT (computed tomography), there is a need to reduce adverse effects, such as beam hardening or scattering artifacts, on reconstructed images. When performing correction using the spectra of incident X-rays estimated using the above method, a structure having a known linear absorption coefficient is required. Moreover, there can be information (e.g., the absorption edge, scattering, etc.) that a hypothetical model for estimation has difficulty in taking into account. For this reason, with respect to X-ray CT, there is still room for improvement in the technology that corrects projection data using the spectra of incident X-rays and a model of an object to be measured such that adverse effects such as beam hardening are reduced.

### Means for Solving Problems

According to an aspect of the present invention, an information processing system is provided, which includes circuitry configured to: acquire projection data representing an X-ray CT projection image related to an object to be measured and an absorption model related to a mode of absorption of X-rays by the object to be measured, the projection data including information on the projection image(s) corresponding to azimuths at which incident X-rays are applied to the object to be measured; generate corrected projection data with respect to each candidate of hypothetical incident X-rays that are hypothesized to be applied to the object to be measured, the corrected projection data being the projection data in which correction on the basis of the candidate of hypothetical incident X-rays and the absorption model is performed; calculate a consistency index indicating a degree of consistency of the corrected projection images corresponding to the azimuths with respect to each of the corrected projection data generated; and output, on the basis of the consistency index, at least one piece of the corrected projection data generated.

Such a configuration can obtain projection data corrected so that the projection data flexibly incorporates information representing the process of absorption of X-rays by the object to be measured, or the like, which existing models have difficulty in taking into account because such information may vary depending on the mode of incidence of X-rays, and so that adverse effects such as artifacts are reduced.

### BRIEF DESCRIPTION OF DRAWINGS

FIG. 1 is a diagram showing an example of the system configuration and hardware configuration of an information processing system 1;

FIG. 2 is a flowchart showing an example of the flow of information processing performed by the information processing system 1;

FIG. 3 is a diagram showing an example of the spectrum of an actual incident X-ray for comparison;

FIG. 4 is a diagram showing an example of the spectrum of a hypothetical incident X-ray that satisfies a convergence condition;

FIG. 5 is an example of a tomographic image of a sample reconstructed without correction;

FIG. 6 is an example of a tomographic image of the sample reconstructed after correction using the actual incident X-ray shown in FIG. 3; and

FIG. 7 is an example of a tomographic image of the sample reconstructed after correction using the hypothetical incident X-ray shown in FIG. 4.

### DETAILED DESCRIPTION

An embodiment of the present invention will be described below with reference to the drawings. Various features described in the present embodiment can be combined with each other.

A program to implement software in the present embodiment may be provided as a computer-readable non-transitory storage medium, or may be provided by download from an external server. The program may also be provided such that it is run on an external computer and its functions are implemented on a client terminal (so-called cloud computing).

In various types of information processing according to the present embodiment, an input and an output corresponding to the input may be made. Information referred to in the information processing (hereinafter referred to as “reference information”) may be in any form as long as an output is obtained as a result of an input. The reference information may be, for example, rule-based information, such as a database, a look-up table, or a predetermined function (including a judgment formula, such as regression formula, constructed using a statistical method), a trained model pre-trained with the correlations between inputs and outputs, or a large-scale language model capable of outputting desired results by inputting a prompt.

The term “unit” in the present embodiment includes, for example, a combination of hardware resources implemented by a circuit in a broad sense and software information processing that can be specifically performed by the hardware resources. Various types of information handled in the present embodiment are represented by, for example, the physical values of signal values representing voltages or currents, high or low signal values as binary bit sets consisting of 0s or 1s, or quantum superpositions (so-called qubits) and can be transmitted and subjected to a calculation on a circuit in a broad sense.

The term “circuit in a broad sense” refers to a circuit implemented by combining at least a circuit, circuitry, a processor, memory, and the like appropriately. The processor may be a general-purpose processor or a dedicated circuit. Specifically, the term “circuit in a broad sense” includes an application-specific integrated circuit (ASIC), programmable logic devices (e.g., a simple programmable logic device (SPLD), a complex programmable logic device (CPLD), a field programmable gate array (FPGA)), and the like.

### 1. System Configuration and Hardware Configuration of Information Processing System 1

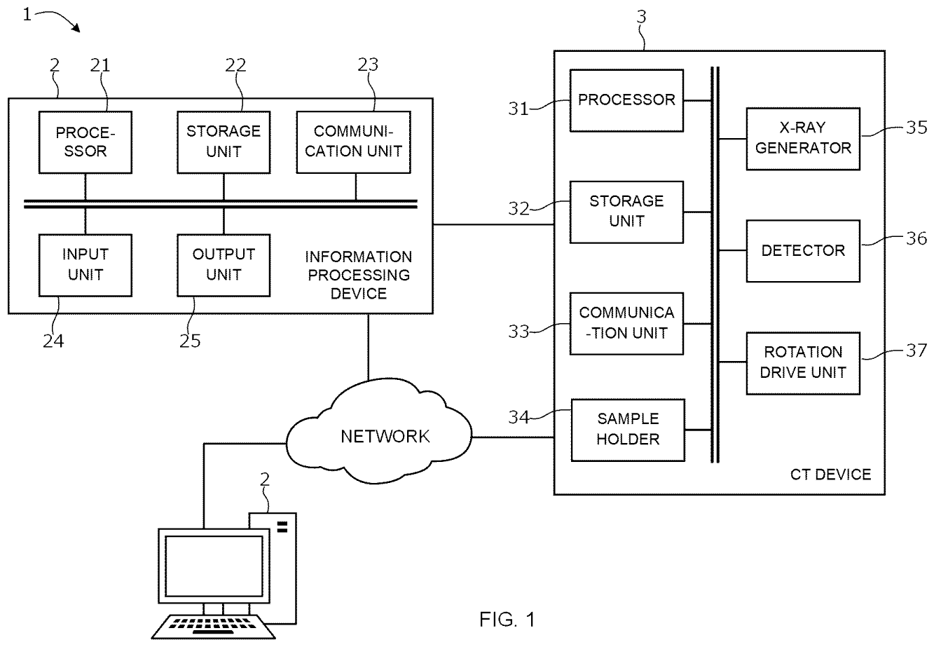

First, referring to FIG. 1, the system configuration and hardware configuration of an information processing system 1 according to the present embodiment will be described. FIG. 1 is a diagram showing an example of the system configuration and hardware configuration of the information processing system 1.

### <Information Processing System 1>

The information processing system 1 shown in FIG. 1 can process multiple projection images captured by a CT device 3. The information processing system 1 includes an information processing device 2 and the CT device 3. The information processing device 2 and CT device 3 are configured to communicate with each other through a communication cable or network. Thus, the information processing device 2 and CT device 3 are able to transmit and receive various types of information to and from each other. Here, the system exemplified by the information processing system 1 consists of one or more devices or components. Accordingly, even the information processing device 2 alone or the CT device 3 alone is included in the system exemplified by the information processing system 1. The information processing device 2 and CT device 3 are operated by, for example, a user who is a measurer.

### <Information Processing Device 2>

The information processing device 2 is a personal computer (PC). The information processing device 2 may be a tablet computer, smartphone, or the like in place of a PC. The information processing device 2 processes multiple projection images captured by the CT device 3. Specifically, for example, the information processing device 2 is configured to perform any information processing on projection data acquired from the CT device 3, control of radiation generated by an X-ray generator 35, acquisition of projection images detected by a detector 36, control of movement of a sample holder 34, control of a rotation drive unit 37, and the like. The information processing device 2 only has to be able to perform any information processing related to the CT device 3 as a result, and any other information processing device may be interposed between the information processing device 2 and the CT device 3. As shown in FIG. 1, the information processing device 2 includes a processor 21, a storage unit 22, a communication unit 23, an input unit 24, and an output unit 25, and these components are electrically connected through a communication bus inside the information processing device 2. The information processing device 2 performs a process according to the present embodiment.

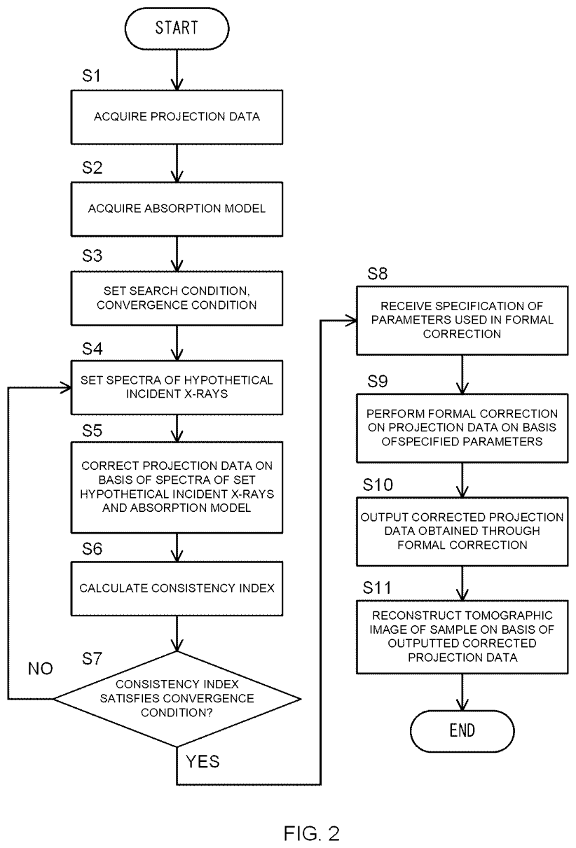

The processor 21 processes and controls overall operation related to the information processing device 2. The processor 21 is, for example, a central processing unit (CPU). When information processing by a program stored in the storage unit 22 is specifically executed by the processor 21, which is an example of hardware, functional units included in the processor 21 are implemented. The functional units included in the processor 21 perform, for example, a process shown in FIG. 2 (to be discussed later). The processor 21 does not have to be a single processor but may include function-specific multiple processors 21. Or, the processor 21 may be a combination of these.

The storage unit 22 is storing various types of information defined by the above description. The storage unit 22 may be embodied, for example, as a storage device such as a solid-state drive (SSD) for storing various programs or the like related to the information processing device 2 executed by the processor 21, or as memory such as random access memory (RAM) for storing temporarily required information (arguments, arrays, etc.) related to program calculations. The storage unit 22 is storing various programs and variables related to the information processing device 2 executed by the processor 21, data used when the processor 21 performs processing on the basis of a program, and the like. The storage 22 may be an example of a storage medium.

While the communication unit 23 preferably uses wired communication means such as USB, IEEE 1394, Thunderbolt®, or wired LAN network communication, it may use wireless LAN network communication, mobile communication such as LTE, 3G, 4G, or 5G, BLUETOOTH® communication, or the like as necessary. Preferably, the communication unit 23 is able to use a set of these multiple communication means. That is, the information processing device 2 may transmit and receive various types of information to and from the outside through the communication unit 23 and any network.

The input unit 24 may be contained in the housing of the information processing device 2 or may be externally attached thereto. For example, the input unit 24 may be embodied as a touchscreen integrated with the output unit 25. If the input unit 45 is a touchscreen, the user can make inputs by performing a tap operation, a swipe operation, and the like thereon. Of course, the input unit 24 may be a switch button, a mouse, a keyboard, or the like in place of a touchscreen. That is, the input unit 24 receives an input based on an operation performed by the user. The input is transferred as a command signal to the processor 21 through the communication bus, and the processor 21 may perform predetermined control or calculation as necessary.

The output unit 25 can function as the display device of the information processing device 2. For example, the output unit 25 may be contained in the housing of the information processing device 2, or externally attached thereto. The output unit 25 displays a graphical user interface (GUI) screen operable by the user. It is preferable to select a display device, such as a CRT display, a liquid crystal display, an organic EL display, or a plasma display, as the output unit 25 in accordance with the type of information processing device 2.

### <CT Device 3>

The CT device 3 is a device capable of applying X-rays to a sample and acquiring projection images of the sample from the amount of X-rays transmitted through it. The CT device 3 is, for example, a sample rotation-type CT device, which rotates the sample holder 34, a gantry-type CT device, which rotates the X-ray generator 35 and detector 36 with respect to the sample holder 34, or the like, but is not limited thereto. The CT device 3 includes a processor 31, a storage unit 32, a communication unit 33, the sample holder 34, the X-ray generator 35, the detector 36, and the rotation drive unit 37, and these components are electrically connected through a communication bus inside the CT device 3. For the processor 31, storage unit 32, and communication 33 of the CT device 3, see the processor 31, storage unit 22, and communication 23 of the information processing device 2.

The sample holder 34 is configured to hold a sample table. The sample holder 34 may be configured to move the sample table in any direction on the basis of a movement instruction made by the processor 21 or processor 31. The sample as an object to be measured is placed on the sample table.

The X-ray generator 35 outputs incident X-rays toward an area including the sample placed on the sample holder 34. The incident X-rays may be continuous X-rays or monochromatic X-rays.

The detector 36 is configured to detect the X-rays transmitted through the sample placed on the sample holder 34. For convenience's sake, the X-rays detected by the detector 36 may be hereinafter referred to as the detected X-rays. The detector 36 is, for example, a two-dimensional detector using a CCD, imaging plate, or the like. The detected X-rays are transmitted as projection data to the information processing device 2 or the like.

The projection data is data obtained through CT measurement by the CT device 3 and represents the X-ray CT projection image(s) related to the sample. More specifically, the projection data includes information on the projection images corresponding to the azimuths at which the incident X-rays are applied to the sample. The azimuths can be defined as, for example, the angles θ of the application directions of the incident X-rays with respect to the reference direction of the sample. The azimuths (in other words, the angles θ) represent the amounts of rotation of a coordinate system in the projection images. The angles θ can be defined, for example, in a range of 0 or more degrees and less than 360 degrees. For example, assuming that the position coordinates of the two-dimensional detector are (x,y), the projection data can be expressed as a data set consisting of the distributions I(x,y) of the intensity I of the detected X-rays corresponding to the angles θ. Hereinafter, the data set consisting of the distributions I(x, y) of the intensity I of the detected X-rays corresponding to the angles θ, in other words, the data set consisting of the intensity distributions I(x, y) corresponding to the measured azimuths characterized by the angles θ may be referred to as the projection data I(x, y, θ). When obtaining the projection data using fan beam projection, Fan2para conversion is performed so that the coordinate system (x, y, θ) is converted into a parallel beam coordinate system. When a cone beam system is used, only the detection results of an area around the central cross section (the center in a y-direction) of a detector capable of regarding incident X-ray beams as fan beams may be used.

The rotation drive unit 37 is configured to control the direction in which an incident X-ray is applied to the sample. Thus, the rotation drive unit 37 is able to change the angle θ (i.e., the azimuth) of the application direction of an incident X-ray with respect to the reference direction of the sample. If the CT device 3 is a sample rotation-type CT device, the rotation drive unit 37 is configured, for example, to rotate the sample holder 34 with respect to the X-ray generator 35 and detector 36. If the CT device 3 is a gantry-type CT device, the rotation drive unit 37 is configured to rotate the X-ray generator 35 and detector 36 with respect to the sample holder 34. The rotation drive unit 37 may include a mechanism capable of adjusting the magnification of projection images to be captured (e.g., a moving mechanism capable of adjusting the distance between the X-ray generator 35 or detector 36 and the sample holder 34).

### 2. Information Processing

This section describes information processing performed by the above information processing system 1. FIG. 2 is a flowchart showing an example of the flow of information processing performed by the information processing system 1. This information processing may include any exception handling (not shown). The exception handling includes interruption of the information processing and omission of any step. Selection or input in the information processing may be performed on the basis of a user operation, or automatically without depending on a user operation.

### [Step S1]

First, in step S1, the processor 21 acquires the projection data I(x, y, θ) from the CT device 3 or other device. At this time, the processor 21 may acquire incidence information.

The incidence information is information on incident X-rays actually applied to the sample. The incident X-rays actually applied to the sample may be incident X-rays outputted from the X-ray generator 35 and actually detected by the detector 36 or the like, or may be spectra as standard values that are guaranteed for the CT device 3 in advance by the manufacturer or the like. The actually applied X-rays may also be spectra back-calculated based on the measurement results to reproduce the actually applied X-rays. For example, the incidence information may include information on the energy ranges of the incident X-rays actually applied to the sample. The information on the energy ranges can be expressed, for example, as the lower and upper limits of energy (in other words, the cutoffs of energy) of the actually applied incident X-rays. The incidence information may include any information characterizing the spectra, such as the peak positions (particularly, the maximum peak positions), peak intensity, peak half-width, and energy-weighted average of the actually applied incident X-rays. The incidence information may also be the spectra themselves of the actually applied incident X-rays. The incidence information may also include information on the energy ranges of the incident X-rays. The information on the energy ranges of the incident X-rays refers to, for example, the upper limits or lower limits of energy of the incident X-rays. The upper limits are preferably the same value as the tube voltage, and the lower limits are preferably determined considering the lower limit of energy detected by the detector or the effects of absorption by the atmosphere.

### [Step S2]

Next, in step S2, the processor 21 acquires an absorption model. The absorption model is information on the mode of absorption of X-rays by the sample and can be expressed, for example, as the spatial distribution of the absorption coefficient f of the sample. These steps S1 and S2 are an example of an acquisition step according to the present embodiment.

The absorption model can be expressed, for example, as a linear absorption coefficient model. The linear absorption coefficient model is the correspondences between the incident X-rays and the transmitted X-rays detected by the detector 36. The linear absorption coefficient model is a function selected to approximate the energy dependence of the distribution of the linear absorption coefficient and can be expressed, for example, as Formula (1) based on the Lambert-Beer's law.

$$[ Formula 1 ]$$

$$I = {\sum }_{b} {D}_{b} exp ( - \int d l f ( {E}_{b} ) ) \qquad ( 1 )$$

In this model, discretized energy is expressed as E_{b} using an index b. In Formula (1), I on the left side represents the intensity of each detected X-ray detected by the detector 36. In Formula (1), D_{b} on the right side represents the intensity of the b-th energy E_{b}, 1 represents the transmission distance of the corresponding incident X-ray through the sample, and integration by 1 means line integration along the transmission path of the incident X-ray. For simplicity, it is assumed that the incident X-ray is a continuous X-ray and is modeled as the superposition of multiple monochromatic X-rays discretized in the energy range. In Formula (1), the nonlinearity of the transmission distance of the X-ray and the attenuation of the X-ray is represented by adding up the attenuation of the respective monochromatic X-rays with the total energy.

As a more specific example, the above linear absorption coefficient model can be expressed as follows using the product of an energy-dependent scale factor s and a linear absorption coefficient f(E₀) depending only on certain reference energy E₀.

$$[ Formula 2 ]$$

$$I = {\sum }_{b} {D}_{b} exp ( - s ( {E}_{b} ) \int d l f ( {E}_{0} ) ) \qquad ( 2 )$$

The scale factor s(E_{b}) is an energy E-related, non-negative function that represents the energy dependence of the linear absorption coefficient and has a value of 1 at the reference energy E₀. The scale factor s can be expressed, for example, as a power function of energy as follows.

$$[ Formula 3 ]$$

$$s ( {E}_{b} ) = {( \frac{{E}_{b}}{{E}_{0}} )}^{α} \qquad ( 3 )$$

In Formula (3), a power exponent α is a parameter that can be set arbitrarily. The scale factor s may be any type of function, such as an exponential function or logarithmic function as long as it is a function that can approximate the energy dependence of the linear absorption coefficient.

### [Step S3]

Next, in step S3, the processor 21 sets a search condition and a convergence condition. Step S3 is an example of a search condition setting step or convergence condition setting step, and the processor 21 that performs step S3 can function as a search condition setting unit or convergence condition setting unit.

The search condition represents a hypothetical incident X-ray search range inputted to the acquired absorption model. A hypothetical incident X-ray is an incident X-ray that is hypothesized to be applied to the sample when calculating the line integral along the transmission path of an incident X-ray of the linear absorption coefficient f on the basis of the absorption model. For convenience's sake, an incident X-ray actually applied to the sample may be hereinafter referred to as the actual incident X-ray so as to be distinguished from the above hypothetical incident X-ray. A hypothetical incident X-ray can be expressed, for example, as a spectrum such as a set of intensities D_{b} at the above energy E_{b}. The search condition is defined, for example, on the basis of the above incidence information. As an example, the processor 21 sets the search condition such that the energy ranges of hypothetical incident X-rays are limited on the basis of the energy ranges of the actually applied incident X-rays (i.e., the actual incident X-rays). Such a configuration suppresses the possibility that even effects that cannot actually occur may be excessively taken into account while reducing the time required for correction, thereby performing more appropriate correction. For example, the processor 21 sets the search condition such that the range of discrete energy E_{b} having finite intensity D_{b} in hypothetical incident X-rays set in step S4 (to be discussed later) is included in a range defined by the lower and upper limits of the actual incident X-rays. The processor 21 may set the search condition such that the position of the maximum peak included in hypothetical incident X-rays is limited on the basis of the position of the maximum peak in the actual incident X-rays (e.g., the distance between both peak positions falls within a specified range). The search condition may be set irrespective of the actual incident X-rays.

The convergence condition is a condition for determining whether a consistency index (to be discussed later) has converged. Any condition, such as whether the value of the consistency index is equal to or less than a specified value indicating convergence or whether the amount of change in the consistency index is equal to or less than a specified value, may be set as the convergence condition.

### [Step S4]

Next, in step S4, the processor 21 sets the spectra of hypothetical incident X-rays. Step S4 is an example of a candidate setting step, and the processor 21 that performs step S4 can function as a candidate setting unit. The spectra of hypothetical incident X-rays set in step S4 are an example of candidate hypothetical incident X-rays that are hypothesized to be applied to the object to be measured. For example, the processor 21 sets candidate hypothetical incident X-rays so as to satisfy the search condition set in step S3. Such a configuration can acquire the projection data appropriately corrected so that the discrepancies with the actual measurement results are reduced. Some of candidate hypothetical incident X-rays may be generated on the basis of the spectra of the incident X-rays actually applied to the object to be measured. Such a configuration can appropriately narrow down the range of correction based on a hypothetical model, thereby reducing the time required for correction. In the present embodiment, in step S4 of the first round, the processor 21 sets the spectra of hypothetical incident X-rays (i.e., the initial model of hypothetical incident X-rays) such that the spectra match the spectra of the actual incident X-rays.

### [Step S5]

Next, in step S5, the processor 21 performs correction on the projection data acquired in step S1 on the basis of each of the candidate hypothetical incident X-rays set in step S4 and the absorption model. Thus, the processor 21 generates corrected projection data. For convenience of explanation, the projection data thus corrected is hereinafter referred to as the corrected projection data.

An example of a process when the correction is beam hardening correction will be described below. Beam hardening correction is correction using a linear absorption coefficient model indicating the energy dependence of the linear absorption coefficient using the scale factor s including parameters. As an example, beam hardening correction is correction performed on the basis of the value of the line integral of the linear absorption coefficient of certain reference energy E₀. For example, as beam hardening correction, the processor 21 calculates the line integral of the linear absorption coefficient f from the detection results (i.e., the projection data) of the detected X-rays on the basis of the reference energy E₀ set in the absorption model acquired in step S2 and the spectra (E_{b}, D_{b}) of the hypothetical incident X-rays set in step S4 in the absorption model represented by Formula (2). Here, the processor 21 optimizes ∫dlf (E₀) such that the intensity distributions I(x, y, θ) of the detected X-rays are reproduced. For example, the processor 21 calculates ∫dlf (E₀) using, for example, the Newton's method that uses the scale factor s (specifically, the power exponent α included in the scale factor) as a parameter, or the like. The specific algorithm for obtaining ∫dlf (E₀) does not have to be the Newton's method but may be the steepest descent method or the like. The processor 21 obtains the line integral of the linear absorption coefficient of the energy E_{b} by multiplying the line integral of the linear absorption coefficient f of the reference energy E₀ by the scale factor s described in Formula (3).

The processor 21 corrects the projection data acquired in step S1 on the basis of the line integral of the linear absorption coefficient f thus calculated. Thus, the processor 21 obtains pieces of corrected projection data. In other words, the pieces of corrected projection data are obtained by performing correction on the projection data on the basis of each of the candidate hypothetical incident X-rays and the absorption model. The pieces of corrected projection data can each include a variable (x, y, θ) corresponding to the uncorrected projection data and an intensity distribution I(x, y, θ) corresponding to the variable.

### [Step S6]

Next, in step S6, processor 21 calculates a consistency index on the basis of the pieces of corrected projection data obtained in step S5. Step S6 is an example of a calculation step, and the processor 21 that performs step S6 can function as a calculation unit.

The consistency index is a value indicating the degree of consistency of the corrected projection images corresponding to the azimuths. In the present embodiment, the consistency index serves as an evaluation function to evaluate the spectrum of each hypothetical incident X-ray for correction. The consistency index may be configured to be increased when the consistency of the corrected projection images corresponding to the azimuths is low and be reduced when the consistency is high. The consistency index can be defined, for example, as normalized root mean square deviation (NRMSD) described below.

$$[ Formula 4 ]$$

$$NRMSD = \sqrt{{\sum }_{k} {( \frac{{M}_{k}}{A v e r a g {e}_{i} ( {M}_{i} )} - 1 )}^{2}} \qquad ( 4 )$$

Mₖ in Formula (4) is defined as follows.

$$[ Formula 5 ]$$

$${M}_{k} = \int m ( k , s ) ds \qquad ( 5 )$$

$$[ Formula 6 ]$$

$$m ( k , s ) = \int {dl}_{k s} f ( r , {E}_{0} ) \qquad ( 6 )$$

s in Formulas (5) and (6) is a parameter representing the detection position and corresponds to, for example, s=(x, y). k is a parameter corresponding to the azimuth of an incident X-ray. For example, k=θ. r in Formula (6) is a coordinate system representing the position of the sample and is a parameter representing the spatial distribution of the linear absorption coefficient f. m(k, s) in Formula (6) is the line integral of the linear absorption coefficient f of the reference energy E₀ on the linear transmission path of a parallel beam-shaped incident X-ray from a position at the angle k toward a certain detection position s. Mₖ in Formula (5) is a value indicating the integral values (in the case of discretely obtained values, the total value) at all the detection positions s of m(k, s) defined by Formula (6). Mₖ is a value indicating, as a single total value, all of the linear absorption coefficient of an incident X-ray (i.e., the mode of absorption of the incident X-ray) from an azimuth characterized by a certain angle k. As the value of Formula (6), the line integral of the linear absorption coefficient f of the reference energy E₀ obtained as a result of the optimization in step S5 may be used.

The processor 21 calculates M₍ₖ₎ with respect to the azimuths with respect to the respective angles k using the correction results of the above corrected projection data in accordance with Formulas (5) and (6). The processor 21 then calculates the consistency index (NRMSD) on the basis of the calculated M₍ₖ₎ with respect to the respective azimuths in accordance with Formula (4). When the consistency of the corrected projection images with respect to the respective azimuths is highest, the values of Mₖ with respect to the respective azimuths are all equal. For this reason, the consistency index takes the minimum value (here, 0). The consistency index does not have to be such an index but may be a parameter indicating variations in the mode of absorption of the incident X-rays corresponding to the respective angles k, such as the variance or standard deviation of Mₖ. In short, the consistency index may be any index as long as it indicates the degree of consistency of the corrected projection images corresponding to the respective azimuths.

### [Step S7]

Next, in step S7, the processor 21 determines whether each of the consistency indexes calculated in step S6 satisfies the convergence condition, as a convergence condition determination step. Step S7 is an example of a convergence condition determination step, and the processor 21 that performs step S7 can function as a convergence condition determination unit. As the convergence condition, the condition set in step S3 is used. For example, if it is determined that none of the consistency indexes calculated in step S6 satisfies the convergence condition, the processor 21 returns to step S4 and again sets the spectra of hypothetical incident X-rays. The processor 21 then performs steps S5 to S7 on the basis of the spectra of the hypothetical incident X-rays set again and recursively generates the pieces of corrected projection data corresponding to the spectra of the hypothetical incident X-rays until one of the consistency indexes satisfies the convergence condition. Such a process (e.g., step S5) is an example of a generation step, and the processor 21 that performs such a step can function as a generation unit. As with the hypothetical incident X-rays set in step S4 of the first round, the hypothetical incident X-rays set recursively in step S4 of the second round are also an example of candidate hypothetical incident X-rays. In this way, the processor 21 generates the pieces of corrected projection data with respect to the respective candidate hypothetical incident X-rays that are hypothesized to be applied to the sample and calculates a consistency index with respect to each of the generated pieces of corrected projection data. As an example, if the processor 21 determines in step S7 that none of the consistency indexes satisfies the convergence condition, the processor 21 recursively performs generation of corrected projection data and calculation of the consistency index in step S6 using candidate hypothetical incident X-rays different from the candidate hypothetical incident X-rays. For example, the processor 21 sets hypothetical incident X-rays in step S4 of the next round on the basis of the candidate hypothetical incident X-rays set in the past (e.g., the candidate hypothetical incident X-rays set in step S4 of the preceding round). Specifically, the processor 21 sets hypothetical incident X-rays that can further optimize the evaluation function such as the above consistency index, in step S4 of the next round. The algorithm for searching for such next hypothetical incident X-rays may be any algorithm, such as local search, iterative improvement, or neighborhood search. This algorithm may be a metaheuristic search method, such as cuckoo search, a genetic algorithm, or particle swarm optimization. The processor 21 may randomly or sequentially select hypothetical incident X-rays from previously set candidate hypothetical incident X-rays and set the spectra thereof. Such candidates may be set on the basis of the search condition as necessary. At this time, at least one of the spectra of the candidate hypothetical incident X-rays may be set irrespective of the similarity with the actual incident X-rays.

The processor 21 may also set hypothetical incident X-rays on the basis of the consistency indexes, regardless of whether the hypothetical incident X-rays are asymptotic to the actual incident X-rays. Such a configuration facilitates incorporation, into hypothetical incident X-rays, of the effects of elements (e.g., the structure of the sample, a higher-order scattering process) that cause more complex artifacts in the sample and thus can reduce artifacts that cannot be reduced through correction using the actual incident X-rays. The similarity between two X-rays can be expressed as the distance between the vectors of variables (e.g., the intensity D (b) of each energy E_{b}) defining the X-rays. This distance can be defined by any index, such as the Manhattan distance, the Euclidean distance, or cosine similarity.

### [Step S8]

In contrast, if the processor 21 determines in step S7 that one of the consistency indexes satisfies the convergence condition, the processor 21, in step S8, receives specification of parameters used in formal correction (to be discussed later). The parameters include information on the spectrum of the hypothetical incident X-ray (E_{b}, D_{b}). Examples of the parameter also include the parameters used in the optimization based on the linear absorption coefficient model, such as the reference energy E₀ and the scale factor s(E_{b}) (the power exponent α, etc.). The parameters may be specified by, for example, the user. At this time, the processor 21 may reconstruct a tomographic image of the sample on the basis of the corrected projection data and display it on the output unit 25. Such a configuration can encourage the user to evaluate the aspect of reductions in the artifacts through the correction selected on the basis of the consistency indexes while comparing it with the tomographic image of the sample obtained through the correction. The parameters may be specified automatically by the processor 21 or the like.

### [Step S9]

Next, in step S9, the processor 21 performs formal correction on the projection data on the basis of the parameters specified in step S8. As formal correction, correction similar to the correction of the projection data in step S5 may be performed, or, again, the line integral value of the linear absorption coefficient f may be optimized using the spectrum of the same hypothetical incident X-ray. In this case, the optimization in step S9 may be repeated with a larger number of times than that of the optimization in step S5. In this way, the processor 21 generates corrected projection data. Therefore, step S9 is also an example of the generation step.

### [Step S10]

Next, in step S10, the processor 21 outputs the corrected projection data obtained through the formal correction as an example of corrected projection data that satisfies the convergence condition. This corrected projection data is final corrected projection data. Step S10 according to the present embodiment is an example of an output step, and the processor 21 that performs step S10 can be an example of an output unit. In other words, the processor 21 outputs at least one of the pieces of corrected projection data obtained in step S5 on the basis of the consistency index. For example, the processor 21 outputs a piece of corrected projection data satisfying the convergence condition from the generated pieces of corrected projection data. If there are multiple pieces of corrected projection data satisfying the convergence condition, the processor 21 may output at least one of those.

### [Step S11]

Next, in step S11, the processor 21 reconstructs a tomographic image of the sample on the basis of the corrected projection data outputted in step S10. The processor 21 presents the reconstructed tomographic image of the sample to the user through the output unit 25.

The processor 21 then ends this information processing. Such a configuration can obtain the projection data corrected so that the projection data flexibly incorporates information representing the process of absorption of X-rays by the object to be measured, or the like, which existing models have difficulty in taking into account because such information may vary depending on the mode of incidence of X-rays, and so that adverse effects such as artifacts are reduced. Moreover, in the above embodiment, the line integral of the linear absorption coefficient f of the sample is treated as an optimization parameter and then the consistency of the absorption modes corresponding to the respective azimuths is evaluated on the basis of the line integral corresponding to the azimuths. Thus, even when information on the structure (shape) of the sample is insufficient (e.g., the structure of the sample is unknown), the correction can be presented, in which the effects of the structure on the distribution of the linear absorption coefficient (see Non-Patent Literature 2, etc.) are incorporated into hypothetical incident X-rays and artifacts can be reduced.

### 3. Example of Results of Above Information Processing

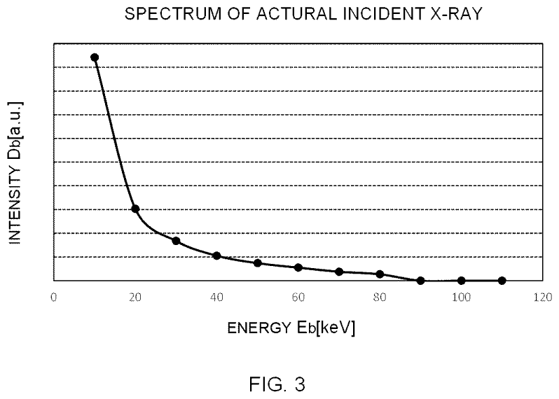

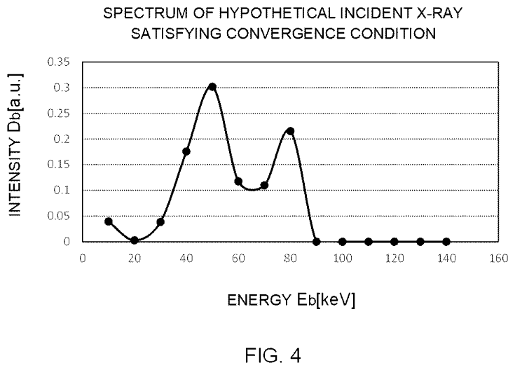

Next, an example of the information processing described in the previous section will be described. FIG. 3 is a diagram showing an example of the spectrum of an actual incident X-ray for comparison. FIG. 4 is a diagram showing an example of the spectrum of a hypothetical incident X-ray satisfying the convergence condition. In this section, the hypothetical incident X-ray shown in FIG. 4 is simply referred to as the hypothetical incident X-ray.

As shown in FIG. 3, the spectrum of the actual incident X-ray has intensities D_{b} greater than 0 in the range of energy E_{b} of 10 to 80 keV and has a single and maximum peak at 10 keV (or in a lower energy range). The spectrum of the actual incident X-ray is the calibration value (i.e., a value actually measured according to a standard) of an X-ray outputted from the X-ray generator 35.

On the other hand, as shown in FIG. 4, in the present embodiment, the hypothetical incident X-ray is represented by a discrete line spectrum having a value of the intensity D_{b} every 10 keV in a range of 10 to 140 keV. As shown in FIG. 4, the spectrum of the hypothetical incident X-ray has finite values greater than 0 in a range of 10 to 80 keV and has three peaks in a range of 10 keV or below and at 50 keV and 80 keV. The energy range included in the spectrum of the hypothetical incident X-ray falls within the energy range of the spectrum of the actual incident X-ray. Of the three peaks, the peak at 50 keV has the highest intensity. As shown in FIGS. 3 and 4, in the present embodiment, the hypothetical incident X-ray corresponding to the consistency index satisfying the convergence condition can have a spectrum completely different from that of the actual incident X-ray in various terms, such as the peak position and the peak intensity ratio.

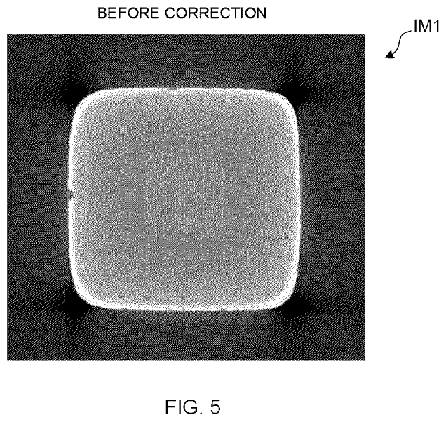

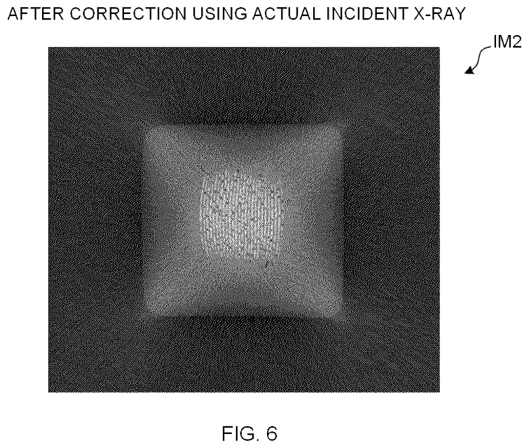

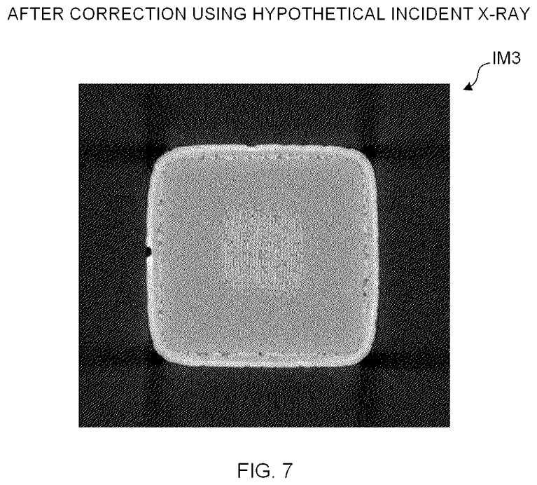

Next, an example of the advantageous effects of the above beam hardening correction using these incident X-rays will be described with reference to reconstructed images. FIG. 5 is an example of a tomographic image of the sample reconstructed without correction. FIG. 6 is an example of a tomographic image of the sample reconstructed after correction using the actual incident X-ray shown in FIG. 3. FIG. 7 is an example of a tomographic image of the sample reconstructed after correction using the hypothetical incident X-ray shown in FIG. 4. A multilayer ceramic capacitor (MLCC) was used as the sample. The power exponent of the exponential function used in the correction performed to obtain the tomographic image shown in FIG. 6 is −3.5, and the power exponent of the exponential function used in the correction performed to obtain the tomographic image shown in FIG. 7 is −4.0. For convenience's sake, the tomographic image shown in FIG. 5 is denoted as IM1, the tomographic image shown in FIG. 6 as IM2, and the tomographic image shown in FIG. 7 as IM3. A white or gray rectangular shadow shown in the center of these tomographic images IM1 to IM3 corresponds to a cross-section of the sample.

As shown in FIG. 5, in the tomographic image IM1 before the correction, the outer edge of the sample and a vertical stripe area inside the sample are blurred in white. This is considered to be due to the effects of artifacts generated during the CT reconstruction. In the tomographic image IM2 obtained by correcting the projection data as the source of such a tomographic image using the actual incident X-ray, a central vertical stripe area is emphasized, while the other area is dark and a bright X-shaped area is formed obliquely from the center of the sample. For this reason, the tomographic image IM2 may be unexpectedly less visible and accurate than the uncorrected tomographic image IM1. Accordingly, the quality of the corrected tomographic image IM2 obtained after the correction using the actual incident X-ray may be unexpectedly lower than that of the uncorrected tomographic image IM1.

On the other hand, as shown in FIG. 7, in the tomographic image IM3 obtained after the correction using the hypothetical incident X-ray satisfying the convergence condition, the outer edge of the sample is clearer than that of the uncorrected tomographic image IM1, and patterns that reduce accuracy, as seen in the tomographic image IM2, are few (or none).

As described above, in the information processing according to the present embodiment, a hypothetical incident X-ray is determined on the basis of the consistency index, irrespective of the similarity in shape (e.g., the peak position, peak intensity ratio, half width, etc.) with the actual incident X-rays. Therefore by incorporating various correction-required factors included in the sample (e.g., a geometrical factor, a higher-order scattering process, etc.) into the hypothetical incident X-ray, artifacts can be further reduced compared to, for example, when performing correction using a hypothetical incident X-ray that simply approximates the actual incident X-rays.

### 4. Another Example of Absorption Model and Another Example of Correction

Next, another example of the absorption model acquired in step S2 and another example of the correction performed in step S5 using the absorption model will be described. The same steps as those of the information processing described above with reference to FIG. 2 will not be described.

The absorption model may include other absorption or scattering process-related components, such as the Klein-Nishina factor f_{KN}. For example, a correction model including a component related to the Klein-Nishina factor f_{KN} can be expressed as follows.

$$[ Formula 7 ]$$

$$I = {\sum }_{b} {D}_{b} exp ( - s ( {E}_{b} ) \int d l f ( {E}_{0} ) - {f}_{K N} ( {E}_{b} ) \int d lp ) \qquad ( 7 )$$

ρ in Formula (7) is a function representing the charge density distribution. The Klein-Nishina factor f_{KN} (E_{b}) is set as necessary. In Formula (7), two variables, that is, the linear absorption coefficient f(E₀) at the reference energy E₀ and the line integral along the X-ray transmission path of each of the linear absorption coefficient f(E₀) and the charge density distribution are optimized toward the intensity I of the detected X-rays with respect to the spectrum D_{b}, scale factor s, reference energy E₀, and Klein-Ninshina factor f_{KN} of a given incident X-ray. Therefore, the number of variables is twice as many as that in the case of performing the above beam hardening correction.

For this reason, in the present embodiment, the processor 21 obtains solutions to the two variables by solving the following nonlinear simultaneous equations using the respective intensity distributions I_{Low}(x, y, θ) and I_{High}(x, y, θ) of detected X-rays obtained by applying two incident X-rays having different energy spectra acquired as the projection data in step S1 of the flowchart shown in FIG. 2.

$$[ Formula 8 ]$$

$${I}_{L o w} = {\sum }_{b} {D}_{Low , b} exp ( - s ( {E}_{b} ) \int d l f ( {E}_{0} ) - {f}_{K N} ( {E}_{b} ) \int d1 ρ ) = \text{} : {F}_{1} ( \int d l f ( {E}_{0} ) , \int d l ρ ) \qquad ( 8 )$$

$$[ Formula 9 ]$$

$${I}_{H i g h} = {\sum }_{b} {D}_{H igh , b} exp ( - s ( {E}_{b} ) \int d l f ( {E}_{0} ) - {f}_{K N} ( {E}_{b} ) \int d l ρ ) = : {F}_{2} ( \int d l f ( {E}_{0} ) , \int d l ρ ) \qquad ( 9 )$$

The processor 21 may calculate solutions to the two variables using any numerical analysis algorithm, such as the multivariable Newton method, on the basis of Formulas (8) and (9) above. The processor 21 may calculate the consistency index on the basis of the line integral of the linear absorption coefficient f(E₀) at the reference energy E₀, which is one of the calculated variables, and then perform step S7. Then, when the consistency index satisfies the convergence condition, the step S8 and subsequent steps are performed so as to a tomographic image of the sample is reconstructed. Correction performed on the basis of multiple pieces of projection data obtained by performing CT imaging using multiple (particularly, two) incident X-rays having different energy spectra as described above is called dual energy correction. Accordingly, the correction may be beam hardening correction or dual energy correction. Such a configuration can obtain the projection data corrected such that the effects of artifacts or the like are reduced more appropriately. These specific modes of correction are not limiting.

### 5. Others

The above embodiment may be modified as follows.

While, in the above embodiment, the hypothetical incident X-rays are described with the degree of freedom like a histogram using the intensities D_{b} of discrete energy E_{b}, hypothetical incident X-rays may be defined otherwise. For example, hypothetical incident X-rays may be described as the superposition of continuous peak distributions, such as Gaussian. In this case, candidate hypothetical incident X-rays are obtained, for example, by changing the peak position, peak intensity, half-width, or the like of each Gaussian.

While, in the above embodiment, the processor 21 sets candidate hypothetical incident X-rays successively one by one by repeatedly performing step S4 and searches for a hypothetical incident X-ray satisfying the convergence condition, candidate hypothetical incident X-rays may be set otherwise. For example, the processor 21 may regularly or randomly extract a specified number of candidate hypothetical incident X-rays from a predetermined search range (e.g., a range defined by the search condition) and calculate the consistency index with respect to the extracted candidates individually or in parallel.

The processor 21 does not have to set the convergence condition. In this case, for example, the processor 21 corrects the projection data on the basis of each set candidate hypothetical incident X-ray and calculates the consistency index. The processor 21 then may determine the corrected projection data to be outputted on the basis of the calculated consistency indexes.

The processor 21 may omit step S8 or step S9 shown in FIG. 2. For example, when the processor 21 determines in step 7 that the consistency index of one hypothetical incident X-ray satisfies the convergence condition, the processor 21 may output the corrected projection data generated using this hypothetical incident X-ray in step S5 as the corrected projection data in step S10.

The processor 21 does not have to set candidate hypothetical incident X-rays on its own, but may acquire candidate hypothetical incident X-rays previously set by any other device and perform correction of the projection data and calculation of the consistency index for each candidate.

The correction model does not have to be the linear absorption coefficient model but may be any model that represents the relationship between the incident X-rays and the transmitted X-rays and/or represents the distribution of the absorption coefficient of the sample. For example, the absorption model may be a mass absorption coefficient model representing the distribution of a mass absorption coefficient.

The information processing device 2 may be in an on-premise form or cloud form. For example, the information processing device 2 in a cloud form may provide the above functions or processing in the form of Saas (Software as a Service) or cloud computing.

While, in the above embodiment, the information processing device 2 performs various types of storage and control, other multiple external devices may be used in place of the information processing device 2. In other words, various types of information and programs may be distributed and stored in multiple external devices using a blockchain technology or the like.

The above embodiment is not limited to the information processing system 1 but may be an information processing method or a program. The information processing method includes steps performed by the information processing system 1. The program causes at least one computer to perform the steps performed by the information processing system 1.

The above information processing system 1 and the like may be provided in aspects below.

(1) An information processing system, comprising: circuitry configured to: acquire projection data representing an X-ray CT projection image related to an object to be measured and an absorption model related to a mode of absorption of X-rays by the object to be measured, the projection data including information on the projection image(s) corresponding to azimuths at which incident X-rays are applied to the object to be measured; generate corrected projection data with respect to each candidate of hypothetical incident X-rays that are hypothesized to be applied to the object to be measured, the corrected projection data being the projection data in which correction on the basis of the candidate of hypothetical incident X-rays and the absorption model is performed; calculate a consistency index indicating a degree of consistency of the corrected projection images corresponding to the azimuths with respect to each of the corrected projection data generated; and output, on the basis of the consistency index, at least one piece of the corrected projection data generated.

Such a configuration can obtain the projection data corrected so that the projection data flexibly incorporates information representing the process of absorption of X-rays by the object to be measured, or the like, which existing models have difficulty in taking into account because such information may vary depending on the mode of incidence of X-rays, and so that adverse effects such as artifacts are reduced.

(2) The information processing system according to (1), wherein the correction is beam hardening correction or dual energy correction.

Such a configuration can obtain the projection data corrected so that the effects of artifacts or the like are reduced more appropriately.

(3) The information processing system according to (1) or (2), wherein: the circuitry is further configured to set the candidate hypothetical incident X-rays such that a search condition defined on the basis of incidence information on the incident X-rays actually applied to the object to be measured is satisfied.

Such a configuration can obtain the projection data appropriately corrected so that the discrepancies with the actual measurement results are reduced.

(4) The information processing system according to (3), wherein some of the candidate hypothetical incident X-rays are generated on the basis of spectra of the incident X-rays actually applied to the object to be measured.

Such a configuration can appropriately narrow down the range of correction using the hypothetical incident X-rays and reduce the time required for correction.

(5) The information processing system according to (3) or (4), wherein: the incidence information includes information on energy ranges of the incident X-rays, and the circuitry is further configured to set the search condition such that energy ranges of the hypothetical incident X-rays are limited on the basis of the energy ranges of the incident X-rays.

Such a configuration suppresses the possibility that even effects that cannot actually occur may be excessively taken into account while reducing the time required for correction, thereby performing more appropriate correction.

(6) The information processing system according to any one of (1) to (5), wherein: the circuitry is further configured to: set a convergence condition, determine whether each of the consistency indexes of the corrected projection data satisfies the convergence condition, recursively perform generation of the corrected projection data and calculation of the consistency indexes using a candidate hypothetical incident X-ray different from the candidate hypothetical incident X-rays when determining not satisfying the convergence condition, and output the corrected projection data satisfying the convergence condition when determining satisfying the convergence condition.

(7) The information processing system according to any one of (1) to (6), wherein reconstruct a tomographic image of the object to be measured from the X-ray CT projection images related to the object to be measured on the basis of the corrected projection data outputted.

(8) An information processing method executed by circuitry, comprising: acquiring projection data representing an X-ray CT projection image related to an object to be measured and an absorption model related to a mode of absorption of X-rays by the object to be measured, the projection data including information on the projection image(s) corresponding to azimuths at which incident X-rays are applied to the object to be measured; generating corrected projection data with respect to each candidate of hypothetical incident X-rays that are hypothesized to be applied to the object to be measured, the corrected projection data being the projection data in which correction on the basis of the candidate of hypothetical incident X-rays and the absorption model is performed; calculating a consistency index indicating a degree of consistency of the corrected projection images corresponding to the azimuths with respect to each of the corrected projection data generated; and outputting, on the basis of the consistency index, at least one piece of the corrected projection data generated.

(9) A non-transitory computer-readable memory medium storing a program for causing at least one computer to perform: acquiring projection data representing an X-ray CT projection image related to an object to be measured and an absorption model related to a mode of absorption of X-rays by the object to be measured, the projection data including information on the projection image(s) corresponding to azimuths at which incident X-rays are applied to the object to be measured; generating corrected projection data with respect to each candidate of hypothetical incident X-rays that are hypothesized to be applied to the object to be measured, the corrected projection data being the projection data in which correction on the basis of the candidate of hypothetical incident X-rays and the absorption model is performed; calculating a consistency index indicating a degree of consistency of the corrected projection images corresponding to the azimuths with respect to each of the corrected projection data generated; and outputting, on the basis of the consistency index, at least one piece of the corrected projection data generated.

Of course, these aspects are not limiting.

Finally, while the embodiment according to the present invention has been described above, the embodiment is only illustrative and are not intended to limit the scope of the invention. The novel embodiment can be carried out in other various forms, and various omissions, replacements, or changes can be made thereto without departing from the gist of the invention. The embodiment and modifications thereof are included in the scope and gist of the present invention, as well as included in the scope of the invention set forth in the claims and equivalents thereof.

What is claimed is:

1. An information processing system, comprising: circuitry configured to:
acquire projection data representing an X-ray CT projection image related to an object to be measured and an absorption model related to a mode of absorption of X-rays by the object to be measured, the projection data including information on the projection image(s) corresponding to azimuths at which incident X-rays are applied to the object to be measured;
generate corrected projection data with respect to each candidate of hypothetical incident X-rays that are hypothesized to be applied to the object to be measured, the corrected projection data being the projection data in which correction on the basis of the candidate of hypothetical incident X-rays and the absorption model is performed;
calculate a consistency index indicating a degree of consistency of the corrected projection images corresponding to the azimuths with respect to each of the corrected projection data generated; and
output, on the basis of the consistency index, at least one piece of the corrected projection data generated.

2. The information processing system according to claim 1, wherein
the correction is beam hardening correction or dual energy correction.

3. The information processing system according to claim 1, wherein:
the circuitry is further configured to set the candidate hypothetical incident X-rays such that a search condition defined on the basis of incidence information on the incident X-rays actually applied to the object to be measured is satisfied.

4. The information processing system according to claim 3, wherein
some of the candidate hypothetical incident X-rays are generated on the basis of spectra of the incident X-rays actually applied to the object to be measured.

5. The information processing system according to claim 3, wherein:
the incidence information includes information on energy ranges of the incident X-rays, and
the circuitry is further configured to set the search condition such that energy ranges of the hypothetical incident X-rays are limited on the basis of the energy ranges of the incident X-rays.

6. The information processing system according to claim 1, wherein:
the circuitry is further configured to:
set a convergence condition,
determine whether each of the consistency indexes of the corrected projection data satisfies the convergence condition,
recursively perform generation of the corrected projection data and calculation of the consistency indexes using a candidate hypothetical incident X-ray different from the candidate hypothetical incident X-rays when determining not satisfying the convergence condition, and
output the corrected projection data satisfying the convergence condition when determining satisfying the convergence condition.

7. The information processing system according to claim 1, wherein
reconstruct a tomographic image of the object to be measured from the X-ray CT projection images related to the object to be measured on the basis of the corrected projection data outputted.

8. An information processing method executed by circuitry, comprising:
acquiring projection data representing an X-ray CT projection image related to an object to be measured and an absorption model related to a mode of absorption of X-rays by the object to be measured, the projection data including information on the projection image(s) corresponding to azimuths at which incident X-rays are applied to the object to be measured;
generating corrected projection data with respect to each candidate of hypothetical incident X-rays that are hypothesized to be applied to the object to be measured, the corrected projection data being the projection data in which correction on the basis of the candidate of hypothetical incident X-rays and the absorption model is performed;
calculating a consistency index indicating a degree of consistency of the corrected projection images corresponding to the azimuths with respect to each of the corrected projection data generated; and
outputting, on the basis of the consistency index, at least one piece of the corrected projection data generated.

9. A non-transitory computer-readable memory medium storing a program for causing at least one computer to perform:
acquiring projection data representing an X-ray CT projection image related to an object to be measured and an absorption model related to a mode of absorption of X-rays by the object to be measured, the projection data including information on the projection image(s) corresponding to azimuths at which incident X-rays are applied to the object to be measured;
generating corrected projection data with respect to each candidate of hypothetical incident X-rays that are hypothesized to be applied to the object to be measured, the corrected projection data being the projection data in which correction on the basis of the candidate of hypothetical incident X-rays and the absorption model is performed;
calculating a consistency index indicating a degree of consistency of the corrected projection images corresponding to the azimuths with respect to each of the corrected projection data generated; and
outputting, on the basis of the consistency index, at least one piece of the corrected projection data generated.
